(19) United States
(12) Patent Application Publication
(10) Pub. No.: US 2024/0005098 A1
(43) Pub. Date: Jan. 4, 2024

(54) METHOD OF USING OPEN-DOMAIN INFORMATION FOR UNDERSTANDING CONTEXT OF TEMPORAL RELATION INFORMATION

(71) Applicant: Korea Advanced Institute of Science and Technology, Daejeon (KR)

(72) Inventors: Ho Jin CHOI, Daejeon (KR); Chae Gyun LIM, Daejeon (KR)

(73) Assignee: Korea Advanced Institute of Science and Technology, Daejeon (KR)

(21) Appl. No.: 18/253,471

(22) PCT Filed: Nov. 15, 2021
(86) PCT No.: PCT/KR2021/016680

§ 371 Date: May 18, 2023

(30) Foreign Application Priority Data
Nov. 23, 2020 (KR) 10-2020-0158017

(51) Int. Cl. G06F 40/284

(52) U.S. Cl. CPC G06F 40/284

(57) ABSTRACT

A method of using open domain information for understanding a context of temporal relation information is implemented as a computer program and performed using a computing device. Unnecessary elements is removed by data pre-processing from an input text in a natural language, and then linguistic characteristics of the pre-processed input text are analyzed to generate a linguistic analysis result in a structure form. Candidates for temporal relation information included in the input text are generated by analyzing temporal information and open domain information included in the input text using the linguistic analysis result, then validity of the candidates is verified to generate verified temporal relation information. Since the temporal relation information can be grasped based on the open-domain information in the input text, quality and accuracy of an information extraction result can be increased in applications, thereby improving system performance for question and answer, document summary, conversation systems, etc.

### CROSS-REFERENCE TO RELATED APPLICATION

This application is a U. S. National Stage Application of International application No. PCT/KR2021/016680 filed on Nov. 15, 2021 which is based upon and claims the benefit of priority to Korean Patent Application 10-2020-0158017, filed on Nov. 23, 2020 in the Korean Intellectual Property Office. The disclosures of the above-listed applications are hereby incorporated by reference herein in their entirety.

### BACKGROUND

### Technical Field

The present invention relates to the field of natural language processing technology, and more particularly, to a method of utilizing open domain information to understand the context of temporal relation information in natural language text data.

### Background Art

In general, documents written using natural language contain temporal information. This temporal information is important in order to accurately understand the semantic content that the author intended to express through the natural language text. In the field of natural language processing research, various studies have been conducted to identify contextual information about the contents described in documents by applying machine learning techniques, and there have been studies that intensively focus on temporal information and grasp the context. Existing technologies for such temporal context information have been mostly processed for input texts written in English, so it is inevitably difficult to apply the technologies to documents based on other languages. The representative reason is that the learning model tends to be dependent on the linguistic characteristics of the input document language because the language analysis results are used in the model processing process.

In addition, existing studies generally analyze whether a temporal relation exists in the input text only from the viewpoint of temporal information extraction technology. Therefore, if the model is sufficiently trained in a certain domain, temporal relation entities can be extracted well, but it tends to be difficult to apply to a new domain.

Open-domain information extraction is a technology that can learn and extract patterns of relation information based on language analysis results such as syntax analysis and dependency analysis based on the given text itself. Accordingly, if the open-domain information extraction is applied, new relation information can be analyzed even when the prior information on a certain domain is insufficient, and thus the usefulness is high.

In the prior art, Korean Patent Publication No. 10-1831058 (title of invention: ‘Open-domain information extraction method and system for extracting concrete ternary relations’), predicates and arguments are analyzed for input text and relation information is generated in the form of a ternary relation of resource description framework (RDF) by using the open-domain information extraction technology. Although the prior art can extract a relation from a general text, temporal entities generated as a result of temporal information extraction are not treated as an analysis target, so it is far from a technology for understanding the temporal context of a given text.

Since the following non-patent document 1 analyzes temporal relation information on input text only from the viewpoint of temporal information extraction technology, temporal relation entities can be extracted when having sufficiently learned about a domain, but it would be difficult for the idea of the document 1 to be applied to a new domain.

Prior Patent Document 1: Korean Patent Publication No. 10-1831058

Prior Non-Patent Document 1: Proceedings of the 31st Annual Conference on Human and Cognitive Language Technology, pp. 081-084, 2019. Temporal Relationship Extraction for Natural Language Texts by Using Deep Bidirectional Language Model

### SUMMARY

### Technical Object

It is an object of the present invention to provide a method of using open domain information for understanding the context of temporal relation information by extracting new temporal relation information, which could not have been addressed in the existing models, through combination and analysis of relation information and temporal entities in natural language text data together so that the narrative flow between entities can be better understood.

The problem to be solved by the present invention is not limited to the above object, and may be variously expanded without departing from the spirit and scope of the present invention.

### Technical Solution

A method of using open domain information for understanding a context of temporal relation information according to an aspect of the present invention is performed using a computing device including at least a processor and a memory device. The method comprises a data pre-processing step of removing unnecessary elements from an input text in natural language; a linguistic analyzing step of analyzing linguistic characteristics of a pre-processed input text to generate a linguistic analysis result in a form of a structure; a relation information expanding step of generating a candidate for temporal relation information included in the input text by analyzing temporal information and open domain information included in the input text using the linguistic analysis result generated in the linguistic analyzing step; and a temporal relation information verifying step of verifying validity of the candidate for temporal relation information.

In an exemplary embodiment, the unnecessary elements may include at least one of unnecessary symbols, special characters, and noise such as continuous space characters in the input text in the natural language.

In an exemplary embodiment, the data pre-processing step may further include performing tokenization and stop word removal processing with respect to the input text in the natural language.

In an exemplary embodiment, the analyzing linguistic characteristics may include at least one of morphological analysis, dependency syntax analysis, semantic ambiguity and entity name recognition on the input text in the natural language.

In an exemplary embodiment, the temporal information may include at least one of a temporal entity that is an expression directly representing a specific date or time, an event entity that is an expression representing an event associated with a time expression in the input text, and a temporal link entity that is an expression representing relation information existing between temporal and event expressions.

In an exemplary embodiment, the open domain information may include, for a relation information that can be represented as a triple in a form of R={S, V, O}, at least one of S which is a subject of a relation, O which is an object of the relation, and V which is a predicate indicating a type of the relation.

In an exemplary embodiment, the temporal relation information may include at least one of combinations of time-time, time-event, and event-event.

In an exemplary embodiment, the relation information expanding step may include a temporal information extracting step of extracting temporal entities included in the input text using the linguistic analysis result; an open-domain relation information extracting step of extracting temporal relation information of the open domain information from the input text by analyzing the open-domain information on the relation between entities based on the linguistic analysis result; and a relation information candidate generating step of discovering new relation information by combining the extracted temporal entities and the extracted temporal relation information of the open domain information.

In an exemplary embodiment, the relation information R may be a relation information that can be expressed as a triple in a form of R={S, V, O}, where S is a subject of the relation, V is a predicate indicating a type of the relation, and O is an object of the relation.

In an exemplary embodiment, the temporal relation information verifying step may include converting all generated relation information candidates into a directed graph form, setting each of temporal entities and event entities as a node in the directed graph, wherein a link between nodes interconnects the nodes corresponding to two entities constituting a temporal relation, and correcting any incorrect link while sequentially searching the nodes for a completed directed graph.

In order to perform method of using open domain information for understanding a context of temporal relation information mentioned above, a computer-executable program stored in a computer-readable recording medium and a computer-readable recording medium in which the computer program is recorded may be provided.

According to the present invention as described above, extraction of the open-domain relation information is used in order to further expand the range of forming temporal relation information contained in the input text in terms of temporal information extraction. In particular, it is possible to generate temporal relation entities that help to understand the temporal context of a given text by utilizing not only the relation entities generated as a result of open information extraction but also the extraction result of temporal information analyzed with the temporal and event entities at the same time.

### Effects of the Invention

According to exemplary embodiments of the present invention, temporal information and open-domain relation information may be analyzed and temporal relation information may be extended in order to understand the temporal context from natural language texts. Through this technology, temporal relation information can be identified based on open-domain information from the input texts, so the quality and accuracy of information extraction results can be improved in actual applications. In particular, the present invention can be applied to a question-and-answer, document summary, conversation system, etc. to improve the performance of the systems therefor.

### BRIEF DESCRIPTION OF THE DRAWINGS

FIG. 1 is a functional block diagram illustrating a configuration of a computer program in which an open-domain information utilization method is implemented for understanding the context of temporal relation information according to an embodiment of the present invention.

FIG. 2 is a functional block diagram illustrating a detailed configuration of a relation information expanding unit according to an embodiment of the present invention.

FIG. 3 illustrates an example of results of temporal information extraction and open-domain relation information extraction according to an embodiment of the present invention.

FIG. 4 is a diagram illustrating an example of verification of temporal relation information according to one embodiment of the present invention.

FIG. 5 is a flowchart illustrating an execution procedure of a method of using open-domain information for understanding the context of temporal relation information according to an embodiment of the present invention.

FIG. 6 illustrates a configuration of a computing device capable of executing the method according to an exemplary embodiment of the present invention.

### DETAILED DESCRIPTION OF THE EMBODIMENTS

The following detailed description of the invention refers to the accompanying drawings, which illustrate, by way of example, specific embodiments in which the present invention may be practiced. These embodiments are described in sufficient detail to enable those skilled in the art to practice the present invention. It should be understood that the various embodiments of the present invention are different but need not be mutually exclusive. For example, certain shapes, structures, and characteristics described herein with respect to one embodiment may be implemented in other embodiments without departing from the spirit and scope of the present invention. In addition, it should be understood that the location or arrangement of individual components in each disclosed embodiment may be changed without departing from the spirit and scope of the present invention. Accordingly, the detailed description set forth below is not intended to be taken in a limiting sense, and the scope of the present invention, if properly described, is limited only by the appended claims, along with all scope equivalents as those claimed. Like reference numerals in the drawings refer to the same or similar functions throughout the various aspects.

Hereinafter, a method of using open domain information for understanding the context of temporal relation information will be described according to an aspect of the present invention with reference to the accompanying drawings.

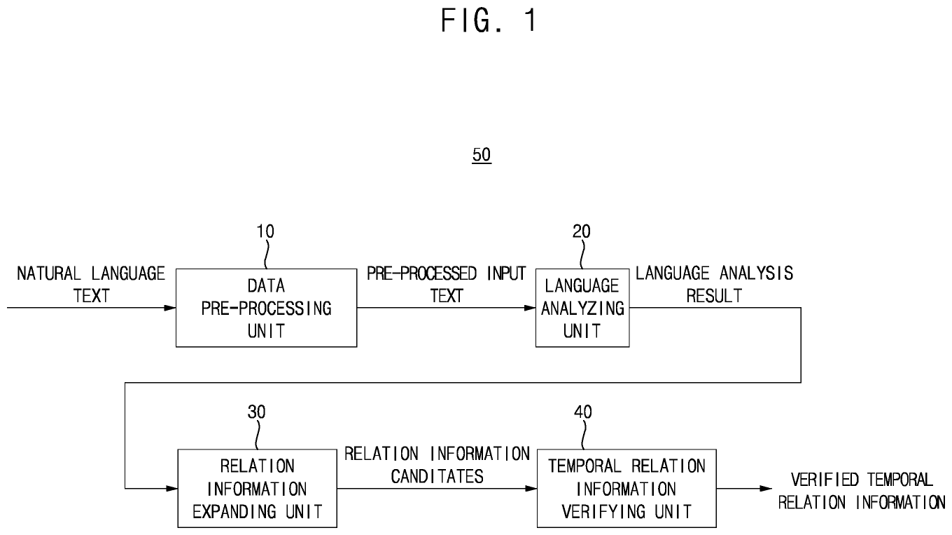

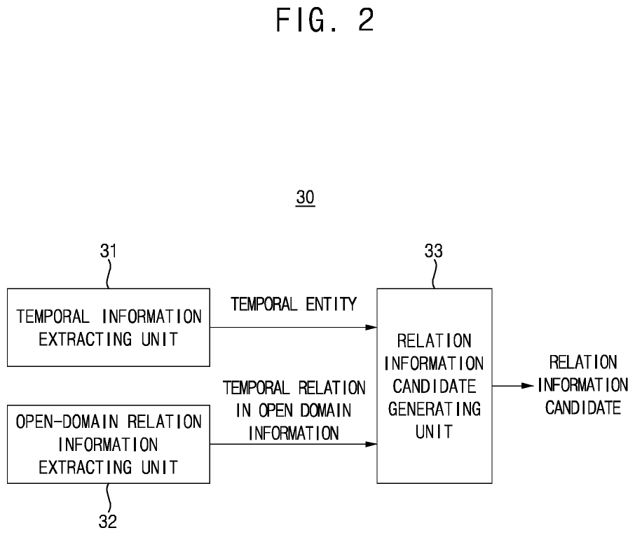

FIG. 1 illustrates a functional block diagram which shows the configuration of an application program for implementing the method of using open domain information for understanding the context of temporal relation information according to an exemplary embodiment of the present invention. FIG. 2 illustrates a functional block diagram which shows the configuration of a relation information expanding unit according to an exemplary embodiment of the present invention.

Referring to FIG. 1, a computer executable application program 50 for the method of using open domain information to understand context of temporal relation information may include, in an exemplary embodiment of the present invention, a data pre-preprocessing unit 10, a language analyzing unit 20, a relation information expanding unit 30, and a temporal relation information verifying unit 40.

A model by the application program 50 according to an exemplary embodiment may receive and process one or more documents written in a natural language text as input data. The natural language text provided as input data may include at least one or more unnecessary elements among symbols, special characters, and noises such as continuous space characters. The data preprocessing unit 10 may remove unnecessary symbols, special characters, and noises such as continuous space characters from the natural language text provided as input, and perform preprocessing such as tokenization and stop word removal. Through such data pre-processing, the model by the application program 50 can efficiently handle texts.

The language analyzing unit 20 may analyze one or more linguistic characteristics among morpheme analysis, dependency syntax analysis, semantic ambiguity, and entity name recognition for a given input text, and convert the language analysis result into a structure type data to be forwarded to the relation information expanding unit 30.

The relation information expanding unit 30 may analyze temporal information and open-domain relation information using the language analysis result, and expand the final relation information by discovering temporal relation information contained in the input text based on the analysis result.

Referring to FIG. 2, the relation information expanding unit 30 will be described in more detail. In an exemplary embodiment, the relation information expanding unit 30 may include a temporal information extracting unit 31, an open-domain relation information extracting unit 32, and a relation information candidate generating unit 33.

The temporal information extracting unit 31 may perform an operation of extracting temporal information, i.e., temporal entities, included in the input text sentence by using the language analysis result provided from the language analyzing unit 20. There are three types of temporal entities: time, event, and temporal link. First, a time object is an expression directly representing a specific date or time, an event object represents events related to a temporal expression in a given text, and a temporal link object represents relation information that exists between times and event expressions. The time link may be composed of combinations of time-time, time-event, and event-event.

The open-domain relation information extracting unit 32, even if it does not have prior information about what domain the input text is about, can extract temporal relation information from the open domain by analyzing words that can express the meaning of the relation between entities based on the language analysis results provided by the language analyzing unit 20 even if it does not have prior knowledge of the specific domain. If one relation information is R, the subject of the relation is S, the object of the relation is O, and the predicate indicating the type of relation is V, then the relation information can be expressed as a triple in the form of R={S, V, O}.

The relation information candidate generating unit 33 may generate a new relation information candidate for the temporal relation information expansion with respect to the input text by combining the temporal entities analyzed by the temporal information extracting unit 31 and the temporal relation information of the open domain information analyzed by the open-domain relation information extracting unit 32. Since a temporal link is a connection between two entities, it is difficult for the temporal link to be matched one-to-one with the relation of open domain information, so that a relation information candidate may be determined based on partial matching for components. In this case, given the relation triple R={S, V, O} in the open domain information, if S or O is a temporal entity or includes an event entity, it can be designated as a candidate for relation information. Also, if V is an event entity, it can be designated as a candidate for relation information.

The temporal relation information verifying unit 40 may convert all the generated relation information candidates into a directed graph form and check the validity of the graph itself. A node of the graph corresponds to a time or event entity, and an edge interconnects nodes corresponding to two entities constituting a temporal relation. In this process, for the completed graph, any incorrect link can be identified and corrected while sequentially searching the nodes.

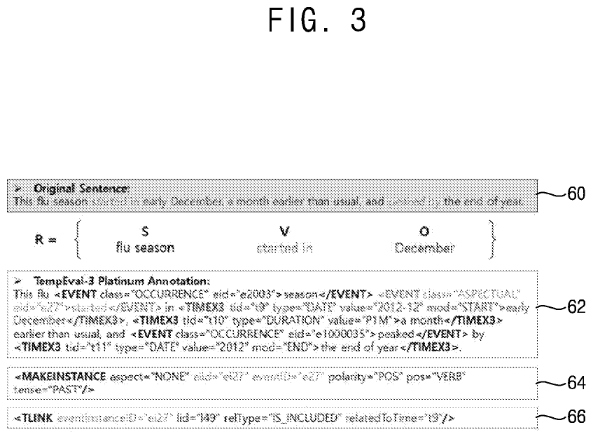

FIG. 3 shows an example of results of temporal information extraction and open-domain relation information extraction according to an embodiment of the present invention.

FIG. 3 is an example of what is expressed in the form of open domain information (i.e., triple of S, V, and O), unlike the prior art of the TempEval annotation method for expressing temporal relation information. Referring to FIG. 3, the open domain information refers to all relation information entities generated from the open domain extraction result. So, the open domain information analyzed by the open-domain relation information extracting unit 32 with respect to the original sentence 60 may be generated in large numbers. That is, all relation information entities that can be generated when a given sentence is analyzed may be included in the open domain information, but in this embodiment, for convenience of description, an arbitrary one-case relation triple R={S, V, O}, that is, R={flu season; started in; December} will be described as an example. In the existing method of TempEval annotation, after inline-tagging time and event entities in a given text, the temporal relation information (tlink) between the entities is separately tagged. In contrast, when the open domain extraction method illustrated in FIG. 3 is applied, it is expressed in a triple structure of R={S, V, O} according to the form of the open domain information, so there is a potential to find new relation information between even more combinations of temporal entities and event entities.

On the other hand, the temporal information extracting unit 31 may analyze an input text 60 to generate an annotation 62 on the identified temporal entity TIMEX3 and the event entity EVENT, and may tag in an XML format the information about MAKEINSTANCE 64, which represents instances of the temporal entity TIMEX3 and the event entity EVENT, and the information about TLINK 66, which represents a relation between the temporal entity and the event entity. In the present embodiment, the wording ‘started in’ is at the V position in the relation R of open domain information while is analyzed as an event entity in the temporal information extraction result. In addition, the word ‘December’ is at position O in relation R, and at the same time it is analyzed as a temporal entity in the temporal information extraction result. Here, if the relation triple R of the open domain information includes temporal relation information, it can be seen that the V part has temporal information along with the S or O part. By utilizing these characteristics, the relation information candidate generating unit 33 may discover a new relation information candidate.

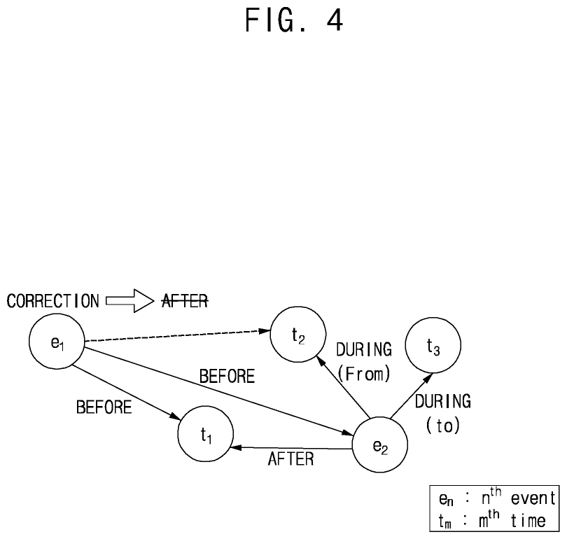

FIG. 4 illustrates an example of temporal relation information verification according to an embodiment of the present invention.

Referring to FIG. 4, two events (e₁, e₂) and three times (t₁, t₂, t₃) constituting five temporal links are shown in a form of directed graph. Entities e₁-e₂ and entities t₁-t₃ are disposed as graph nodes, and the following combinations are connected by links according to the relation information.

TABLE 1

| No. | Subject of Relation | Type | Object of Relation |
|---|---|---|---|
| 1 | e₁ | BEFORE | t₁ |
| 2 | e₁ | BEFORE | e₂ |
| 3 | e₁ | AFTER | t₂ |
| 4 | e₂ | AFTER | t₁ |
| 5 | e₂ | DURING | (t₂, t₃) |

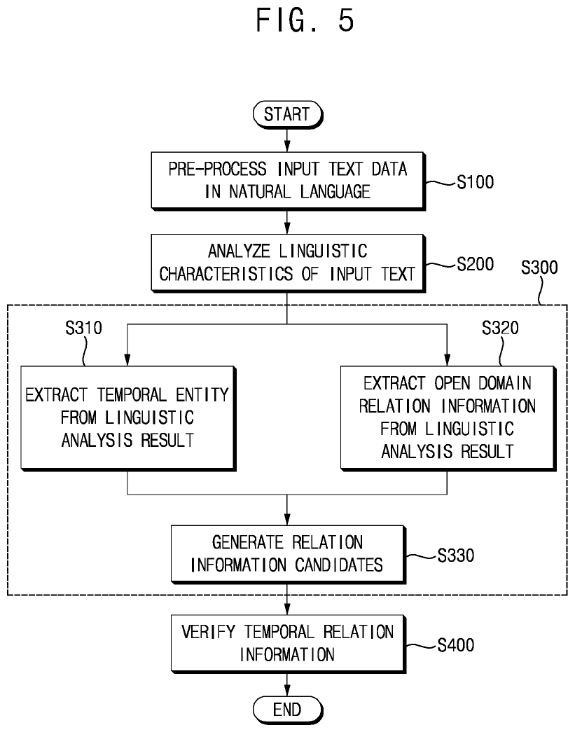

Here, in the case of 3^{rd} combination {e₁, ATFER, t₂}, the fact that e₁<e₂ and t₁<t₂ is clearly shown from the temporal view, and thus it is shown that the combination is determined as a bad connection to be corrected. The contents of [Table 1] can be represented in the form of a graph as shown in FIG. 4. In the graph, if the time flow of entity is expressed in one timeline, it can be expressed as ‘e₁->BEFORE t₁->BEFORE [t₂->e₂->t₃]_{DURING}.’ Accordingly, the 3^{rd} combination of Table 1, t₂->_{AFTER} e₁, must be at the time (BEFORE) prior to t₁, so it is judged as an incorrect connection and it is shown that a correction processing is performed. FIG. 5 is a flowchart which illustrates an execution procedure of a method for using open domain information for understanding the context of temporal relation information according to an embodiment of the present invention.

Referring to FIG. 5, in the data pre-processing unit 10, removal of noises such as unnecessary symbols, special characters, and continuous blank characters from the natural language input text, tokenization of the input text and stop word removal from the input text may be processed firstly (S100). The pre-processed input text may be provided to the language analyzing unit 20.

The language analyzing unit 20 may analyze linguistic characteristics such as morpheme analysis, dependency syntax analysis, semantic ambiguity, and entity name recognition for the preprocessed input text (S200). The results of the linguistic characteristic analysis may be provided to the relation information expanding unit 30. The results of linguistic characteristic analysis such as morpheme analysis, dependency syntax analysis, semantic ambiguity, and entity name recognition may be delivered as text data in a JSON format which includes each analysis result as illustrated below. Alternatively, the linguistic characteristic result may be expressed in another format such as XML.

(Example of result of linguistic characteristic analysis)

{
“morp”: [{“text”: “morpheme 1 text”, “type”: “NNP”}, ...],
“dependency”: {“root”: “node”, “type”: “node type”, “child”: [...]},
...
}

Next, the relation information expanding unit 30 may perform analysis of the temporal information and open-domain relation information using the result of the language analysis to extract temporal entity information and temporal relation information, and combine the two kinds of information to discover temporal relation information embedded in the input text, thereby expanding the final relation information (S300).

Specifically, the temporal information extracting unit 31 may extract temporal entities included in the input text sentence by using the result of the language analysis provided from the previous step (S310).

In addition, the open-domain relation information extracting unit 32 may analyze the open domain information on the relation between the entities from the input text, and extract the relation information expressed as a triple in the format of R={S, V, O} (S320).

When the temporal entity and the temporal relation of the open domain information are extracted as described above, the relation information candidate generating unit 33 may generate a new relation information candidate for the input text by combining the temporal entities and the temporal relation of the open domain information together (S330). The generated new relation information candidates may be provided to the temporal relation information verifying unit 40.

Next, the temporal relation information verifying unit 40 may convert all the generated relation information candidates into a directed graph form and check the validity of the graph itself (S400).

Through this process, new temporal relation information may be obtained by combining the relations between the temporal entities and the open domain information, and it may be validated to better understand the context of the narrative flow or temporal relation information.

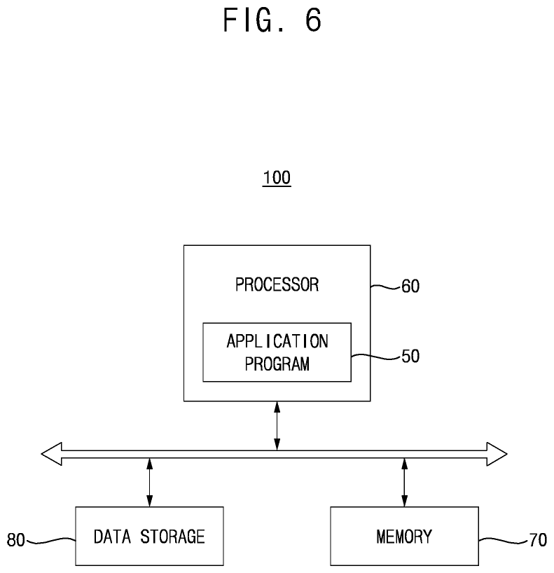

FIG. 6 illustrates a configuration of a computing device capable of executing the method according to an exemplary embodiment of the present invention.

Referring to FIG. 6, the method according to the embodiment of the present invention may be implemented as an application program, and the method may be performed by executing the application program in the computing device 100. The computing device 100 may include, as hardware resources, a processor 60, a memory 70, and a data storage 80. The processor 60 may be implemented as a processing device, for example, a central processing unit (CPU), a microprocessor, a digital signal processor, or the like. The memory 70 that provides the data processing work space necessary for the arithmetic processing of the processor 60 may be implemented as, for example, a DRAM device. The data storage 80 may be implemented as a hard disk driver, a flash memory device, or the like capable of maintaining a recorded state of data regardless of whether power is turned on or off. Data generated by the application program 50 and the processor 60 executing the application program 50 may be stored in the data storage 80.

As described above, the method according to the embodiment of the present invention has a major difference from the prior patent document 1 in that the method of the present invention employs the idea of the open-domain relation information extraction in order to further expand the range of forming the temporal relation information contained in the input text in terms of the temporal information extraction. In particular, the present invention differs from the Prior Patent Document 1 in that the relation information expanding unit 30 of the present invention can generate temporal relation entities that help to understand the temporal context of the text given as input by simultaneously using not only relation entities generated as the results of open domain information extraction, but also the results of temporal information extraction analyzed from temporal entities and event entities. The method according to the present invention is also different from the Prior Non-Patent Document 1 in that the method can analyze new relation information (open domain information) without prior information about the domain by incorporating the open domain relation information extraction technology, and can analyze new temporal relation information by combining these relations and temporal entities.

Features, structures, effects, etc. described in the above embodiments are included in any one embodiment of the present invention, and are not necessarily limited to just one embodiment. Furthermore, features, structures, effects, etc. illustrated in each embodiment can be combined or modified for other embodiments by those of ordinary skill in the art to which the embodiments belong. Accordingly, the technical features related to such combinations and modifications should be interpreted as being included in the scope of the present invention.

In addition, although the present invention has been described above with reference to embodiments, these are merely illustrative and not limiting, and one of ordinary skill in the field to which the invention belongs will recognize that many modifications and applications not illustrated are possible without departing from the essential features of the embodiments. For example, the present invention may be practiced in a different order than the method specifically described in the embodiments, or with different components than the components of the devices or systems described. And such variations and differences in application should be construed as falling within the scope of the invention as defined by the appended claims.

### INDUSTRIAL APPLICABILITY

The present invention can be used in various fields requiring natural language text processing technology.

1. A method of using open domain information for understanding a context of temporal relation information, performed using a computing device comprising at least a processor and a memory element, and the method comprising:
a data pre-processing step of removing unnecessary elements from an input text in a natural language;
a linguistic analyzing step of analyzing linguistic characteristics of a pre-processed input text to generate a linguistic analysis result in a form of a structure;
a relation information expanding step of generating a candidate for temporal relation information included in the input text by analyzing temporal information and open domain information included in the input text using the linguistic analysis result generated in the linguistic analyzing step; and
a temporal relation information verifying step of verifying validity of the candidate for temporal relation information.

2. The method of claim 1, wherein the unnecessary elements include at least one of unnecessary symbol, special character, and noise including continuous space character in the input text in the natural language.

3. The method of claim 2, wherein the data pre-processing step further comprises performing tokenization and stop word removal processing on the input text in the natural language.

4. The method of claim 1, wherein the analyzing linguistic characteristics includes at least one of morphological analysis, dependency syntax analysis, semantic ambiguity and entity name recognition on the input text in the natural language.

5. The method of claim 1, wherein the temporal information includes at least one of a temporal entity that is an expression directly representing a specific date or time, an event entity that is an expression representing an event associated with a time expression in the input text, and a temporal link entity that is an expression representing relation information existing between temporal and event expressions.

6. The method of claim 1, wherein the open domain information includes, for a relation information that can be represented as a triple in a form of R={S, V, O}, at least one of S which is a subject of a relation, O which is an object of the relation, and V which is a predicate indicating a type of the relation.

7. The method of claim 1, wherein the temporal relation information includes at least one of combinations of time-time, time-event, and event-event.

8. The method of claim 1, wherein the relation information expanding step comprises a temporal information extracting step of extracting temporal entities included in the input text using the linguistic analysis result; an open-domain relation information extracting step of extracting temporal relation information of the open domain information from the input text by analyzing the open-domain information on the relation between entities based on the linguistic analysis result; and a relation information candidate generating step of discovering new relation information by combining the extracted temporal entities and the extracted temporal relation information of the open domain information.

9. The method of claim 8, wherein the relation information R is a relation information that can be expressed as a triple in a form of R={S, V, O}, where S is a subject of the relation, V is a predicate indicating a type of the relation, and O is an object of the relation.

10. The method of claim 1, wherein the temporal relation information verifying step may include converting all generated relation information candidates into a directed graph form, setting each of temporal entities and event entities as a node in the directed graph, wherein a link between nodes interconnects the nodes corresponding to two entities constituting a temporal relation, and correcting any incorrect link while sequentially searching the nodes for a completed directed graph.

11. A computer-executable program stored in a computer-readable recording medium to perform the method of using open domain information for understanding a context of temporal relation information according to claim 1.

12. A computer-readable recording medium in which a computer-executable program for performing the method of using open domain information for understanding a context of temporal relation information according to claim 1 is recorded.
